(19) United States
(12) Patent Application Publication
(10) Pub. No.: US 2006/0129460 A1
(43) Pub. Date: Jun. 15, 2006

(54) Internet service provider branded facades

(75) Inventor: Timothy Tobin, Raymore, MO (US)

Correspondence Address: THORP REED & ARMSTRONG, LLP, ONE OXFORD CENTRE, 301 GRANT STREET, 14TH FLOOR, PITTSBURGH, PA, 15219-1425, US

(73) Assignee: Innerfund, Ltd.

(21) Appl. No.: 11/008,022

(22) Filed: Dec. 9, 2004

(51) Int. Cl. G06Q 30/00

(52) U.S. Cl. 705/26

(57) ABSTRACT

A system and method that allows an Internet Service Provider (ISP) to attract and keep more subscribers (while greatly reducing the funds needed for advertising, branding and promotion) by marketing an entity (e.g., a nonprofit organization) as the provider of an Internet services and offering the Internet service on behalf of the entity such that the entity appears to the subscribers as the provider of the Internet service. The Internet service has the “look and feel” of the entity while the ISP runs the hardware, software, and logistical support to provide the Internet service. Thus, the entity is not required to provide the Internet service. The subscribers may be chosen from a group of supporters of the entity. The entity is thus represented as the “brand” of the Internet service and the subscribers may be encouraged to show their support to the entity through subscription to the Internet service. A monetary rebate may be offered to a subscriber for each month of continued subscription to the Internet service, and the subscriber may be allowed to redirect the rebate to the entity as a show of the subscriber's support to the entity and its activities, thereby providing an additional source of funding to the entity. Because of the rules governing abstracts, this abstract should not be used to construe the claims.

### BACKGROUND

1. Field of the Disclosure

The present disclosure generally relates to the Internet and, more particularly, to a system and method to provide Internet access services using virtual Internet Service Providers (ISPs).

2. Brief Description of Related Art

There are a large number of commercial entities offering subscription-based ISP services (e.g., access to the Internet via a broadband or a dial-up connection) to customers (or Internet users). These companies spend advertising dollars through various marketing channels to attract and maintain their subscribers. However, this customary approach to marketing involves a significant expenditure of money and human resources to expand the ISP's customer base and also to retain the existing customers. Therefore, it is desirable to devise a scheme that allows the ISP to attract and keep more subscribers while greatly reducing the funds needed for advertising, branding and promotion of ISP's services.

### SUMMARY

The present disclosure contemplates a method which comprises marketing an entity as an Internet Service Provider (ISP) to users of ISP services. A subscription-based Internet service is offered on behalf of the entity to the users such that the entity appears to the users as the provider of the Internet service.

In one embodiment, the present disclosure contemplates a computer system, which, upon being programmed, is configured to perform a method comprising identifying an entity associated with a user of a subscriber computer connected to the computer system; and providing an Internet service to the subscriber computer on behalf of the entity such that the entity appears to the user as the provider of the Internet service.

In another embodiment, the present disclosure contemplates a method which comprises contacting supporters of an entity, marketing the entity to the supporters as a provider of a subscription-based Internet service, and providing the Internet service on behalf of the entity to each subscriber of the Internet service such that the entity appears to each subscriber as the provider of the Internet service.

A system and method according to the present disclosure allows an Internet Service Provider (ISP) to attract and keep more subscribers (while greatly reducing the funds needed for advertising, branding and promotion) by marketing an entity (e.g., a nonprofit organization) as the provider of an Internet services and offering the Internet service on behalf of the entity such that the entity appears to the subscribers as the provider of the Internet service. The Internet service has “look and feel” of the entity while the ISP runs the hardware, software, and logistical support to provide the Internet service. Thus, the entity is not required to provide the Internet service. The subscribers may be chosen from a group of supporters of the entity. The entity is thus represented as the “brand” of the Internet service and the subscribers may be encouraged to show their support to the entity through subscription to the Internet service. A monetary rebate may be offered to a subscriber for each month of continued subscription to the Internet service, and the subscriber may be allowed to redirect the rebate to the entity as a show of the subscriber's support to the entity and its activities, thereby providing an additional source of funding to the entity.

### BRIEF DESCRIPTION OF THE DRAWINGS

For the present disclosure to be easily understood and readily practiced, the present disclosure will now be described for purposes of illustration and not limitation, in connection with the following figures, wherein:

FIG. 1 is a block diagram illustrating an exemplary arrangement to implement the virtual Internet service provider scheme according to one embodiment of the present disclosure; and

FIG. 2 depicts an exemplary flowchart showing a process flow for the virtual Internet service provider methodology according to one embodiment of the present disclosure.

### DETAILED DESCRIPTION

Reference will now be made in detail to some embodiments of the present disclosure, examples of which are illustrated in the accompanying drawings. It is to be understood that the figures and descriptions of the present disclosure included herein illustrate and describe elements that are of particular relevance to the present disclosure, while eliminating, for the sake of clarity, other elements found in typical Internet-based systems. It is noted at the outset that the terms “connected”, “connecting,” “electrically connected,” etc., are used interchangeably herein to generally refer to the condition of being electrically connected.

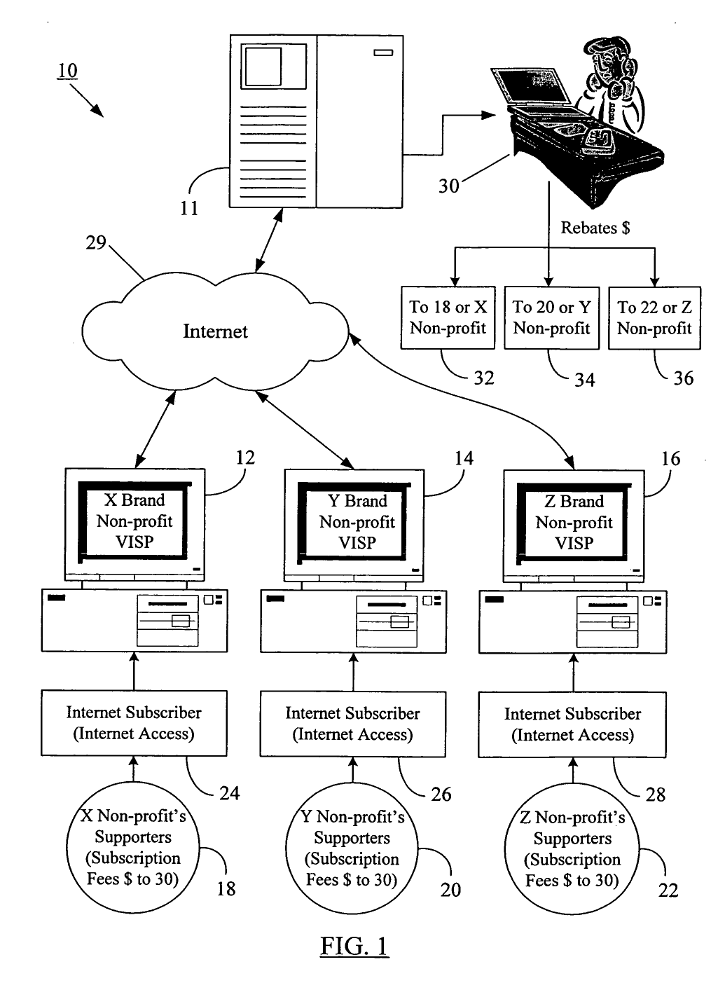

FIG. 1 is a block diagram illustrating an exemplary arrangement 10 to implement the virtual Internet service provider scheme according to one embodiment of the present disclosure. The arrangement 10 may include a server 11 (which may be a server farm depending on the load to be handled) that is configured to provide a number of “facades” or individualized ISP platforms to various subscribers of Internet services as discussed later hereinbelow. As noted before, traditional providers (ISPs) of Internet services are generally required to expend large amount of advertising dollars (e.g., for mass mailings or television advertisements) to attract and retain subscribers of their ISP services. On the other hand, according to one embodiment of the present disclosure, an ISP can attract and maintain subscribers by utilizing and presenting the known “brand” of an entity as the ISP's own to create a “brand facade.”

It is noted that the term “entity”, as used herein, refers to one or more of the following (although the list is not exhaustive): a well-known person, a non-profit organization, a for-profit organization or corporation, or any other company (e.g., a credit union) (commercial or non-commercial) having a group of supporters or well-wishers. Furthermore, the terms “Internet service” and “ISP service” are used interchangeably below to refer to one or more of the following types of Internet-based services (although the list presented here is not exhaustive): Internet access service (e.g., broadband or dial-up access), website hosting, domain registration, online software downloads, online content delivery (e.g., news, weather, sports, entertainment, etc.), online customer support, e-mail delivery (e.g., via the Internet), online marketing of various products and services, etc.

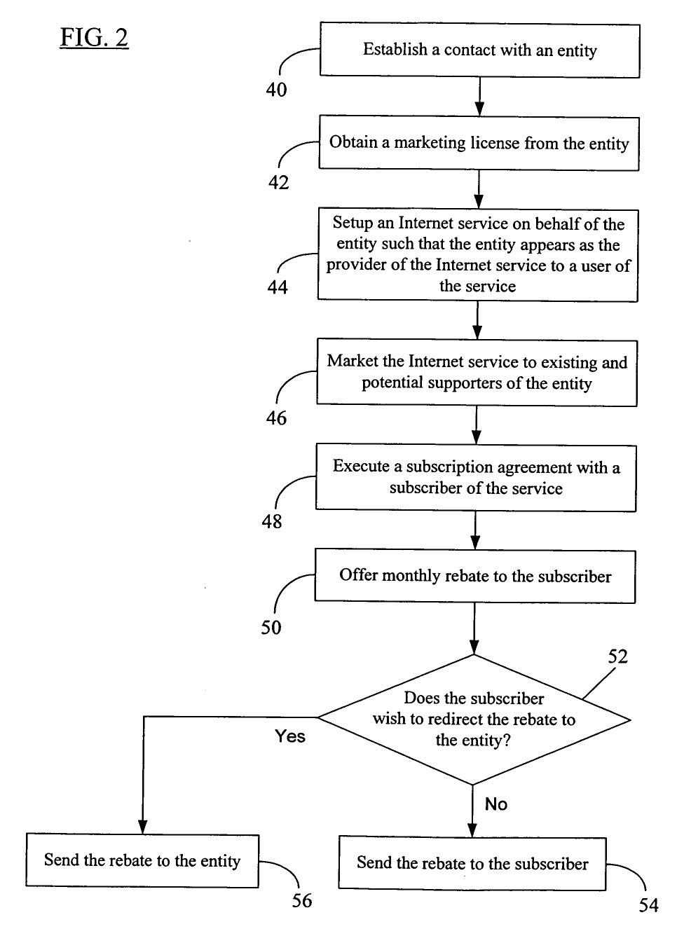

FIG. 2 depicts an exemplary flowchart showing a process flow for the virtual Internet service provider methodology according to one embodiment of the present disclosure. In the following discussion, the arrangement 10 in FIG. 1 is described with reference to the flowchart in FIG. 2. Initially, at block 40 in FIG. 2, a traditional Internet service provider (ISP) that is desirous of expanding its customer base according to the methodology of the present disclosure may establish a contact with the entity (e.g., a non-profit organization), for example, through a marketing inquiry initiated by the ISP or in response to a similar inquiry from the entity. During marketing negotiations, the ISP may obtain a license or permission by the entity to use the name or “brand equity” or “goodwill” of the entity to market various services of the ISP to a target audience comprising of specific followers, supporters or well-wishers of the entity (block 42, FIG. 2). After receiving the license or needed approval from the entity, the ISP may setup an Internet service platform on behalf of the entity to be marketed to the target audience in a manner such that the entity appears as the provider of the Internet service to a user/subscriber of the service (block 44, FIG. 2). Thus, the entity may function as a “virtual” ISP even though all the hardware, software, and logistics involved in offering the ISP services on behalf of the entity may be handled “behind the scenes” by the commercial ISP that approached the entity for the rights to use the entity's “brand equity” or “goodwill” to obtain customers.

Specifically, the ISP may execute a licensing agreement (preferably for no money) with certain entities (e.g., non-profits) that allows the ISP to use the respective entity's brand as the identity of the provider of Internet services to be marketed to the entity's supporters and potential supporters. The ISP may then commence marketing of its Internet-related services to existing and potential supporters of the entity (block 46, FIG. 2). In FIG. 1, three sets of supporters for three separate entities X, Y, and Z are indicated by the reference numerals 18, 20, and 22, respectively. The ISP may obtain the supporter list from the corresponding entity (preferably without a fee) and may contact those supporters (current or potential) from the list who are not presently subscribers of ISP's Internet service. These potential subscribers or clients may be contacted via telephone calls, targeted postal mailings, e-mails, etc.

The licensed use of an entity's brand for the ISP's Internet service results in creation of a “brand façade,” wherein the name, logo, and entire “look” (e.g., in traditional advertisements or literature) associated with the entity are presented or represented through all phases, from marketing to potential subscribers, to logon to URL (Uniform Resource Locator), homepage (website and portal), e-mail branding, instant message branding, personal website branding, billing for services, etc. In other words, for all intents and purposes, the ISP projects the “look and feel” of the entity (e.g., a non-profit organization, a credit union, etc.) while the ISP runs the entire structure underneath or behind that “façade.” For example, the ISP may provide the logistics and support for such services as subscriber sign-up, billing, customer support, e-mail account set-up and maintenance, all branding for marketing, and content delivery (e.g., news, weather, sports, entertainment, etc.). The entity may not be required to provide any hardware, software, or logistical support to run the operations for the entity-specific Internet service.

In FIG. 1, the server 11 is shown to provide Internet service to subscriber computers 12, 14, and 16 via respective connections through the Internet 29. Thus, as illustrated in FIG. 1, when Internet subscribers 24, 26, 28 access the Internet 29 through the subscribers' computer 12, 14, and 16, respectively, the computers may project the “look and feel” of the entity supported by the corresponding subscriber. For example, if the ISP's Virtual Internet Service Partner (VISP) is an X non-profit organization, then an Internet subscriber 24 supporting the X nonprofit may see the X nonprofit's name, logo, and other familiar indicia as the Internet homepage for that subscriber. Similar entity-specific homepages for Y and Z nonprofits may also appear for the subscribers 26 and 28, respectively, as shown in FIG. 1. The server 11 may be configured to store and transmit the entity-specific web pages to respective subscribers based on the subscriber's information contained in the subscription agreement (discussed hereinbelow) executed by the subscriber. For example, during marketing of entity-specific Internet service to that entity's supporters, the ISP may include an entity-specific reference code in each marketing material sent to the supporters of a specific entity. The reference code may be required by the subscriber to sign-up for the Internet service. In that manner, the ISP may identify the set of entity-specific web pages and marketing materials (stored in the server 11) to be sent to the subscriber's computer for presentation to the subscriber when the subscriber signs up for the Internet service (e.g., through a dial-up or broadband connection) and commences browsing of various sections or web links on the entity-specific homepage presented on the subscriber's computer.

As noted above, each subscriber from the entity-specific marketing by the ISP may be required to execute a subscription agreement with the ISP (block 48, FIG. 2). The subscription agreement may allow the subscriber to receive a monthly rebate (from the fees paid by the subscriber for the Internet service) for each month the subscriber remains a customer of the ISP's Internet service (block 50, FIG. 2). The rebate may be a fixed amount or may be variable based on the total monthly spending of the subscriber as part of the subscription fees for the Internet service as well as subscriber's spending at one or more merchants featured at the homepage of the Internet service. Other suitable arrangements for rebate awards may be devised as is known in the art. In the subscription agreement, the subscriber may be given an option to either redirect the rebate each month to the ISP's Virtual Internet Service Partner (VISP) (i.e., the entity whose “brand name” is marketed to the subscriber by the ISP) or to request that the rebate be sent to the customer each month. The subscriber may be given an option to receive a portion of the rebate and send the remainder of the rebate to the VISP, thereby “splitting” the rebate with the entity of choice. The rebate may be sent as a check to the customer or may be applied as a credit against the customer's account balance for the succeeding month. In one embodiment, the subscription agreement may provide rebate accumulation for a specific time (e.g., three months) before the rebate is mailed to the client. Various other rebate delivery arrangements may be devised as is known in the art.

The rebate preference indicated by the subscriber may be stored in the central server 11 and monitored by an administrator 30 for the ISP. Alternatively, the server 11 may be programmed to automatically report the rebate preference to the administrator 30 whenever a new subscriber signs-up for the Internet service. If the subscriber has indicated to redirect the rebate to the entity supported by the subscriber (block 52 in FIG. 2), then the administrator 30 may perform appropriate system programming (to configure the server 11 or other relevant processing computer (not shown)) so that the accrued monthly rebates are automatically issued to the respective entities (e.g., the X, Y, and Z non-profits as indicated at blocks 32, 34, and 36, respectively, in FIG. 1) as indicated at block 56 in FIG. 2. The administrator 30 may program the system in such a manner that all rebates (from various subscribers) to be redirected to a specific entity (e.g., the X non-profit) may be accumulated for each subscriber (supporting that entity) and the total amount may be sent to the entity rather than separate rebates containing subscriber-specific amounts. On the other hand, if the subscriber does not wish to redirect the subscriber-specific rebate to the subscriber's entity of choice, the rebate, in that case, may be sent to the subscriber (block 54, FIG. 2) in one of the manners discussed hereinbefore and as shown at blocks 32, 34, and 36 in FIG. 1. Thus, although the subscription fees collected from an entity's supporters (who happen to be the subscribers of the entity-specific Internet service provided by the administrator 30 through the server 11) are paid to the service administrator 30 (as indicated at 18, 20, and 22 in FIG. 1), the rebates from those fees may be distributed to the subscriber's entity of choice as discussed here.

As noted before, the server 11 may contain a number of servers (a server farm) to cope with increasing subscriber load or to provide an entity-specific, dedicated server for each group of entity-specific subscribers. All of the computers served by the server 11 may be linked to the server 11 via the Internet 29. Thus, as illustrated in FIG. 1, each subscriber's web browsing experience may be “logged” or “recorded” in the server 11 (through the Internet-based connection to the subscriber's computer 12, 14, 16) and monitored by the administrator 30 (or a group of administrators) to determine what type of subscriber- and entity-specific marketing be targeted to the subscriber. In the embodiment of FIG. 1, the three computers 12, 14, and 16 are shown linked to the same server 11 via the Internet 29, but the server 11 may be configured to deliver different entity-specific web pages on respective subscriber's computer. In this embodiment, the server 11 may associate each subscriber's computer ID (e.g., an IP (Internet Protocol) address) with the specific entity the subscriber supports, thereby linking entity-specific material (stored on the server 11) to its correct receiving terminal/computer.

The above described arrangement allows an ISP to attract and maintain subscribers by utilizing and presenting the known “brand” of an entity (e.g., a nonprofit) as the provider of the Internet service. Instead of spending the customary advertising dollars to attract subscribers, the ISP may “borrow” the “brand equity” in an existing entity to attract and maintain subscribers. It also allows the ISP a flexibility to show a multitude of fronts or brands, thereby giving the ISP the power of presenting not just one known brand, but many brands. On the other hand, the virtual Internet service provider arrangement according to the present disclosure allows an entity to utilize their brand equity in a more effective way (higher number of impressions and increased funding) on the Internet. For example, in case of a nonprofit organization, such an arrangement allows the nonprofit to educate the public about its cause, obtain increased involvement and participation from targeted audiences, develop new volunteers and leaders to advertise and promote the nonprofit's work, etc. In case of a for-profit entity, the virtual Internet service provider arrangement may increase brand equity and organizational identity, more product distribution power, and may allow access to new customers and current employees. Through such virtual ISP arrangement according to the present disclosure, the for-profit entity may receive increased customer loyalty, sales, improved employee morale and relations, enhanced corporate image, positive media attention, and a socially responsible reputation.

The rebate arrangement discussed hereinbefore may allow the subscriber to redirect part of a current expenditure to a charitable cause (e.g., to a nonprofit charitable entity supported by the subscriber) and all the related personal goodwill that entails. Under the arrangement 10 discussed hereinbefore, a nonprofit's supporters (including its employee base), for example, may recognize the “brand” of their Internet service provider and wish to support it (through, for example, redirecting their rebates). The entity's (or Virtual Internet Service Partner's) motivation to participate in such delivery of Internet service using the entity as a virtual Internet service provider may be secured by enlisting the entity's supporters to subscribe for the Internet service that appears to be offered by the entity and that has a “licensed look” providing legitimacy and credibility to the ISP's marketing efforts. Thus, even though a customer may realize that the entity supported by the customer is not the actual ISP of the Internet service (in terms of hardware, software, and logistical support required to offer and maintain the service), the customer may still continue to subscribe to the service because of the “entity-sponsored” nature of the service and because of the credibility resulting from the familiar, entity-specific “look and feel” the customer receives when accessing the entity-specific homepage on the Internet.

As discussed hereinbefore, the methodology according to the present disclosure may use three specific processes in unison: (1) the presentation of multiple entities as Internet Service Provider brands, (2) rebates to the subscribers from the “real” or actual Internet Service Provider, and (3) funding to the entity through redirected rebates from the subscribers. In case of a nonprofit, the rebates may be key to compensating the nonprofit for increased utilization of its “brand” without requiring the nonprofit to directly participate in a for-profit venture. The subscriber may realize that the nonprofit's appearance as its ISP is only a façade, but may want that façade in order to show the subscriber's support and respect for the nonprofit mission. The nonprofit-branded Internet service according to one embodiment of the present disclosure may thus assist the commercial ISP to expand its customer base while greatly reducing the finds needed for advertising, branding, and promotion of its Internet services had the ISP decided to market the services in the traditional manner.

The foregoing describes a system and method that allows an Internet Service Provider (ISP) to attract and keep more subscribers (while greatly reducing the finds needed for advertising, branding and promotion) by marketing an entity (e.g., a nonprofit organization) as the provider of an Internet services and offering the Internet service on behalf of the entity such that the entity appears to the subscribers as the provider of the Internet service. The Internet service has the “look and feel” of the entity while the ISP runs the hardware, software, and logistical support to provide the Internet service. Thus, the entity is not required to provide the Internet service. The subscribers may be chosen from a group of supporters of, or past or potential donors to, the entity. The entity is thus represented as the “brand” of the Internet service and the subscribers may be encouraged to show their support to the entity through subscription to the Internet service. A monetary rebate may be offered to a subscriber for each month of continued subscription to the Internet service, and the subscriber may be allowed to redirect the rebate to the entity as a show of the subscriber's support to the entity and its activities, thereby providing an additional source of funding to the entity.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A method, comprising:
marketing an entity as an Internet Service Provider (ISP) to users of ISP services; and
offering a subscription-based Internet service on behalf of said entity to said users such that said entity appears to said users as the provider of said Internet service.

2. The method of claim 1, further comprising:
establishing a marketing association with said entity.

3. The method of claim 2, wherein said establishing includes licensing said entity's trademarks and logos to said ISP.

4. The method of claim 1, wherein said users include past and potential donors of said entity.

5. The method of claim 1, further comprising:
offering a monetary rebate to each subscriber of said subscription-based Internet service;
and
allowing said subscriber to select at least one of the following as a recipient of said rebate:
said subscriber, and
said entity.

6. The method of claim 5, further comprising:
executing a subscription agreement with each said subscriber of said subscription-based Internet service; and
allowing said subscriber to select said recipient as part of said subscription agreement.

7. The method of claim 5, further comprising:
sending said rebate to said recipient.

8. The method of claim 1, wherein said entity includes non-profit entities.

9. A computer system, which, upon being programmed, is configured to perform a method comprising:
identifying an entity associated with a user of a subscriber computer connected to said computer system; and
providing an Internet service to said subscriber computer on behalf of said entity such that said entity appears to said user as the provider of said Internet service.

10. The computer system of claim 9, which, upon being programmed, is configured to perform a method further comprising:
presenting a subscription agreement for said Internet service to said user via said subscriber computer, wherein said subscription agreement contains an offer of monetary rebate to said user for using said Internet service;
allowing said user to electronically execute said subscription agreement and to select in said subscription agreement at least one of the following as a recipient of said rebate:
said user, and
said entity; and
storing said subscription agreement as executed by said user.

11. The computer system of claim 10, which, upon being programmed, is configured to perform a method further comprising:
sending said rebate to said recipient; and
alerting an administrator of said computer system to send said rebate to said recipient.

12. A method, comprising:
contacting supporters of an entity;
marketing said entity to said supporters as a provider of a subscription-based Internet service; and
providing said Internet service on behalf of said entity to each subscriber of said Internet service such that said entity appears to each said subscriber as the provider of said Internet service.

13. The method of claim 12, wherein said marketing includes:
obtaining a permission from said entity to market said entity to supporters thereof.

14. The method of claim 12, further comprising:
offering an incentive to each subscriber for continued subscription of said Internet service;
allowing said subscriber to redirect said incentive to said entity; and
sending said incentive to said entity as per instructions from said subscriber.

15. The method of claim 14, wherein said incentive is in the form of a monetary rebate.

16. The method of claim 12, wherein said entity includes non-profit entities.
